(19) United States
(12) Patent Application Publication
(10) Pub. No.: US 2025/0085721 A1
(43) Pub. Date: Mar. 13, 2025

(54) GENERATION DEVICE, ROBOT, GENERATION METHOD, AND PROGRAM

(71) Applicant: Preferred Robotics, Inc., Tokyo (JP)

(72) Inventors: Takafumi WATANABE, Tokyo (JP); Ryutaro MURAYAMA, Tokyo (JP); Koji TERADA, Tokyo (JP)

(21) Appl. No.: 18/825,133

(22) Filed: Sep. 5, 2024

(30) Foreign Application Priority Data
Sep. 8, 2023 (JP) 2023-145968

(51) Int. Cl. G05D 1/667; G05D 1/223; G05D 101/00; G05D 105/28; G10L 15/22

(52) U.S. Cl. CPC G05D 1/667; G05D 1/223; G05D 2101/22; G05D 2105/28; G10L 15/22; G10L 2015/223

(57) ABSTRACT

A generation device includes at least one memory; and at least one processor. The at least one processor is configured to acquire information from a user; generate input information for a generation module based on robot information related to a robot and the acquired information; and acquire a program for controlling an operation of the robot, the program being generated by inputting the input information into the generation module. The robot information includes information related to at least one of an operating environment of the robot or a software component for acquiring information related to the operating environment.

### CROSS-REFERENCE TO RELATED APPLICATIONS

This patent application is based on and claims priority to Japanese Patent Application No. 2023-145968 filed on Sep. 8, 2023, the entire contents of which are incorporated herein by reference.

### TECHNICAL FIELD

The present disclosure relates to a generation device, a robot, a generation method, and a program.

### BACKGROUND

Robots that can recognize external conditions by sensors or by communication and perform actions according to the conditions are known. Some of such robots operate according to a program created in advance.

### RELATED ART DOCUMENT

### Patent Document

[Non-Patent Document 1] Sai Vemprala, Rogerio Bonatti, Arthur Bucker, and Ashish Kapoor, “ChatGPT for Robotics: Design Principles and Model Abilities”, [online], [retrieved on Aug. 28, 2023]

### SUMMARY

According to an aspect of the present disclosure, a generation device includes at least one memory; and at least one processor. The at least one processor is configured to acquire information from a user; generate input information for a generation module based on robot information related to a robot and the acquired information; and acquire a program for controlling an operation of the robot, the program being generated by inputting the input information into the generation module. The robot information includes information related to at least one of an operating environment of the robot or a software component for acquiring information related to the operating environment.

### BRIEF DESCRIPTION OF THE DRAWINGS

FIG. 1 is a block diagram illustrating an example of an overall configuration of a control system;

FIG. 2 is a drawing illustrating an example of an external configuration of an autonomous vehicle;

FIG. 3A and FIG. 3B are drawings each illustrating a state in which the autonomous vehicle is docked with a shelf to be transferred;

FIG. 4 is a block diagram illustrating an example of a functional configuration of a generation device;

FIG. 5 is a flowchart illustrating an example of a generation process;

FIG. 6 is a flowchart illustrating an example of an edit process;

FIG. 7 is a flowchart illustrating an example of an execution process; and

FIG. 8 is a block diagram illustrating an example of a hardware configuration of the generation device.

### DETAILED DESCRIPTION

In the following, embodiments of the present disclosure will be described with reference to the accompanying drawings. Here, in the specification and the drawings, components having substantially the same functional configuration are denoted by the same reference numerals, and duplicated description thereof will be omitted.

### Embodiment

An embodiment of the present disclosure is a control system configured to control an operation of a robot. The control system creates a program for controlling the operation of the robot in order to realize an instruction to the robot provided by a user. The program for controlling the operation of the robot is stored in a storage unit, such as a memory included in the robot, and is executed by a control device included in the robot in response to a predetermined trigger.

In the embodiment, the robot includes, for example, a sensor and a movement mechanism. The robot has a function of recognizing an external condition by a sensor or by communication and performing an operation according to the external condition. Additionally, the robot may have a function of actively moving, exercising, or the like in order to acquire information related to its own operating environment. For example, a robot operating in a house of the user can move to the vicinity of an entrance and perform an operation of directing a camera toward a door such that the door is within the angle of view of the camera in order to detect that the user has returned home.

In order to create the program for controlling the operation of the robot, specialized knowledge related to software engineering is required. Therefore, it is extremely difficult for a user who is not familiar with software engineering to provide the action principle of the robot as the program.

For example, simply arranging the operations expected for the robot is synonymous with simply automatically pressing buttons for instructing the operations in order, and therefore, it is easy in many cases. With respect to the above, planning and instructing an operation involving condition determination, conditional branching, and the like in advance requires expert knowledge, skills, and the like, such as knowledge about the robot, programming background, and selection of information necessary for determining the condition. For example, assuming a robot that operates in a house, it is necessary to enable even a user who does not have such expert knowledge to easily create a program.

In order to cause the robot to perform an operation expected by the user, the following three points are main problems. The first problem is to convert an expected condition into an operation of the robot. The second problem is to define operations to be performed by the robot by a task, a conditional branch, or the like. The third problem is to implement a task, a conditional branch, and exception handling in a program.

A method for the user to give a new action principle to the robot is described below. The order of the methods listed below is the order in which the difficulty level for the user is considered to be higher.

The first method is to write the program in a programming language. The second method is to create the program by using a simplified tool, such as visual programming. The third method is to describe a flowchart representing a desired operation.

The fourth method is to describe a sentence indicating a desired operation in a natural language. Examples of the sentence include “Bring a towel to the bath. When I get out, bring beer from the refrigerator”. The fifth method is to declare an expected condition in a natural language. Examples of the sentence include “I want to drink beer after getting out of the bath and feeling refreshed”.

The embodiment of the present disclosure realizes to create a program for controlling an operation of a robot by the fourth method and the fifth method described above. Additionally, the embodiment of the present disclosure realizes to create a program in the third method at the same time. In one aspect, according to the present embodiment, even a user who does not have expert knowledge can easily create a program for controlling an operation of a robot.

### <Overall Configuration of Control System>

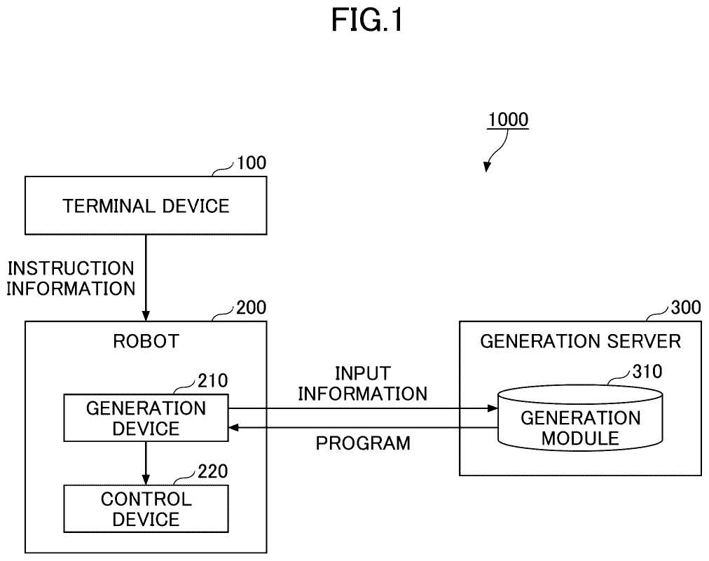

An overall configuration of the control system according to the present embodiment will be described with reference to FIG. 1. FIG. 1 is a block diagram illustrating an example of the overall configuration of the control system according to the present embodiment.

As illustrated in FIG. 1, a control system 1000 according to the present embodiment includes a terminal device 100, a robot 200, and a generation server 300. The terminal device 100, the robot 200, and the generation server 300 are communicably connected to each other via a communication network, such as a local area network (LAN) or the Internet.

The terminal device 100 is an information processing terminal, such as a personal computer, a smartphone, or a tablet terminal operated by a user of a robot 200. The terminal device 100 receives an input of instruction information indicating an instruction to the robot provided by the user and transmits the instruction information to the robot 200. Additionally, the terminal device 100 displays a programming screen for editing the generated program to the user, and updates the program in accordance with the user's operation on the programming screen. The terminal device 100 may include a display device for displaying the programming screen.

The robot 200 is a robot that can autonomously operate according to the program. The robot 200 includes a generation device 210 and a control device 220.

The generation device 210 transmits input information for generating a program to the generation server 300 based on the instruction information. The generation device 210 receives the program from the generation server 300 and stores the program in a storage unit, such as a memory.

The control device 220 reads the program stored by the generation device 210 in the storage unit and executes the program in response to a predetermined trigger. The control device 220 may execute the program generated by the generation device 210 offline. The control device 220 may execute the program generated by the generation device 210 online.

Here, the term “offline” indicates that a program is generated in advance and the program is automatically executed in response to a trigger defined in advance. In contrast, the term “online” indicates that a program is generated in real time and executed every time an instruction is given by a user.

The program executed offline needs to be created assuming various states in advance, and thus the programming difficulty increases. The generation device 210 generates a program based on various information including information related the robot 200 itself, information related to an operating environment of the robot 200, information related to the user, and the like, and thus can create a complicated program that is executable offline.

The robot 200 includes at least a sensor and a movement mechanism, and performs an operation including movement in accordance with an external condition recognized by the sensor or the like. In the present embodiment, the robot 200 is, for example, an autonomous vehicle that further includes a docking mechanism and that docks to a transferred body to transfer an object designated by the user to a designated location. The transferred body is, for example, an article of furniture, such as a shelf with casters.

As another example, the robot 200 may be a household robot that performs household tasks, such as cleaning, a service robot that provides various services by using an arm having a large number of joint points, a convey robot that conveys luggage, equipment, or the like in a factory, a warehouse, or the like, an automatic driving vehicle that travels on a public road or a private road, a transport drone that flies while holding goods or the like, or the like.

The autonomous vehicle, which is an example of the robot 200, identifies a shelf on which a target object designated by the user is placed, and detects the position of the shelf. Additionally, the autonomous vehicle docks to the shelf by using the docking mechanism and moves to a location designated by the user in the docked state. As described above, the autonomous vehicle achieves the transfer of the target object designated by the user to the designated location.

The generation server 300 is an information processing device, such as a personal computer, a workstation, or a server that generates a program in response to a request from the generation device 210. The generation server 300 includes a generation module 310. The generation server 300 receives the input information from the generation device 210 and inputs the input information into the generation module 310 to generate a program. The generation server 300 transmits the generated program to the generation device 210.

The generation module 310 is configured to generate a program for controlling the robot. The generation module 310 may be, for example, a generative model trained, by using a command written in a natural language as an input, to interpret the meaning of the command, and output a program according to the meaning of the command. The generative model may be, for example, a large scale language model. The generation module 310 may be an action planning system as another example. The generation module 310 has learned general common sense, and interprets the command under the common sense to generate a program.

The program in the present embodiment is a Turing complete programming language. The program can be executed by using an application programming interface (API) provided by the robot 200 as an embedded function. A program can also call another program during execution.

The APIs of the robot 200 can be classified into multiple categories. The first category is an API that causes the robot 200 to perform a predetermined task (hereinafter, also referred to as an “execution API”). The second category is an API that acquires sensor data from the sensor included in the robot 200 (hereinafter, also referred to as an “acquisition API”). The third category is an API that calculates predetermined information based on the sensor data (hereinafter, also referred to as a “calculation API”). The calculation API may calculate the predetermined information by using a defined program provided by a manufacturer of the robot 200, for example.

Here, the overall configuration of the control system 1000 illustrated in FIG. 1 is an example, and various system configuration examples can be adopted according to the application and purpose. The control system 1000 may be configured by one or more devices. Respective functions included in the control system 1000 may be realized by suitable devices constituting the system. Each component included in the control system 1000 may be included in any device constituting the system.

For example, the generation module 310 may be included in the generation device 210. Additionally, for example, the generation module 310 may be included in the terminal device 100 or the robot 200. Further, for example, the generation module 310 may be distributed and held in an external information processing system including multiple devices. In this case, the control system 1000 need not include the generation server 300. Additionally, for example, the generation device 210 need not be included in the robot 200, may be included in the terminal device 100, or may be included in the control system 1000 as another independent device or system. Further, for example, the instruction information may be directly input to the robot 200 without the intervention of the terminal device 100. In this case, the control system 1000 need not include the terminal device 100.

The control system 1000 may include multiple of one or more of the terminal device 100, the robot 200, or the generation server 300. For example, the generation device 210, the control device 220, or the generation server 300 may be implemented by multiple computers or may be implemented as a service of cloud computing. The classification of the devices, such as the terminal device 100, the robot 200, the generation device 210, the control device 220, and the generation server 300 illustrated in FIG. 1 is an example.

### <External Configuration of Autonomous Vehicle>

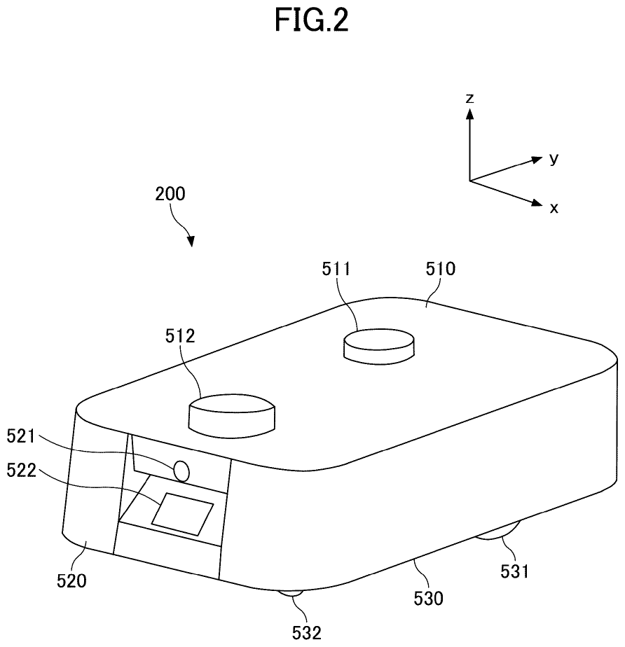

An external configuration of an autonomous vehicle 200, which is an example of the robot 200, will be described. FIG. 2 is a drawing illustrating an example of the external configuration of the autonomous vehicle.

As illustrated in FIG. 2, the autonomous vehicle 200 has a cuboid shape as a whole, and dimensions in a height direction (z-axis direction) and a width direction (x-axis direction) are defined so that the autonomous vehicle 200 can enter a lower side of a lowermost level of the shelf, which is the transferred body. Here, the shape of the autonomous vehicle 200 is not limited to a cuboid.

A locking device 511, which is a member constituting a docking mechanism for docking to the shelf to be transferred, is installed on an upper surface 510 of the autonomous vehicle 200. Additionally, a laser imaging detection and ranging (LiDAR) 512 is installed on the upper surface 510 of the autonomous vehicle 200. The LiDAR 512 has a measurement range in the front-rear direction (y-axis direction) and the width direction (x-axis direction) at the height position of the upper surface 510 of the autonomous vehicle 200, and an obstacle or the like in the measurement range can be detected by using a measurement result by the LiDAR 512.

A front RGB camera 521 and a time of flight (ToF) camera 522 are installed on a front surface 520 of the autonomous vehicle 200. Here, the front RGB camera 521 of the present embodiment is installed on the upper side of the ToF camera 522, but the installation position of the front RGB camera 521 is not limited to this position.

When the autonomous vehicle 200 moves in the forward direction, the front RGB camera 521 captures images of, for example, the shelf to be transferred, a user near the transfer destination, an installation near the transfer destination, an obstacle on the transfer path, and the like, and outputs a color image.

The ToF camera 522 is an example of a distance image sensor, and is installed facing upward on the front surface 520 of the autonomous vehicle 200 to such an extent that a traveling surface on which the autonomous vehicle 200 travels is not included in the measurement range, in order to avoid the multipath problem. Examples of the multipath problem include deterioration in the measurement accuracy due to the fact that light emitted from a light source is reflected by another object via a floor surface and the reflected light is received by the ToF camera 522. In the present embodiment, the upward installation angle of the ToF camera 522 on the front surface 520 of the autonomous vehicle 200 is assumed to be about 50 degrees with respect to the floor surface.

Additionally, when the autonomous vehicle 200 moves in the forward direction, the ToF camera 522 captures an image of an obstacle or the like by using at least a region where the docked shelf passes (a region corresponding to the height of the docked shelf×the width of the docked shelf) as the measurement range, and outputs a distance image (depth image). Here, in the present embodiment, the vertical angle of view of the ToF camera 522 is 70 degrees, and the horizontal angle of view is 90 degrees.

A drive wheel 531 and an idler wheel 532 are installed on a lower surface 530 of the autonomous vehicle 200 to support the autonomous vehicle 200. The drive wheel 531 and the idler wheel 532 are an example of the moving mechanism.

The drive wheels 531 are installed one by one in the width direction (x-axis direction) (two in total are installed in the width direction), and by each of the drive wheels 531 being independently driven by a motor, the autonomous vehicle 200 can be caused to move in the forward/backward direction (y-axis direction). Additionally, the drive wheels 531 can also cause the autonomous vehicle 200 to turn about the z-axis.

The idler wheels 532 are installed one by one in the width direction (x-axis direction) (two in total in the width direction). The idler wheels 532 are installed so as to be turnable around the z-axis with respect to the autonomous vehicle 200. Here, the installation position and the number of the idler wheels 532 to be installed may be other than those described above.

### <Overview of Docking>

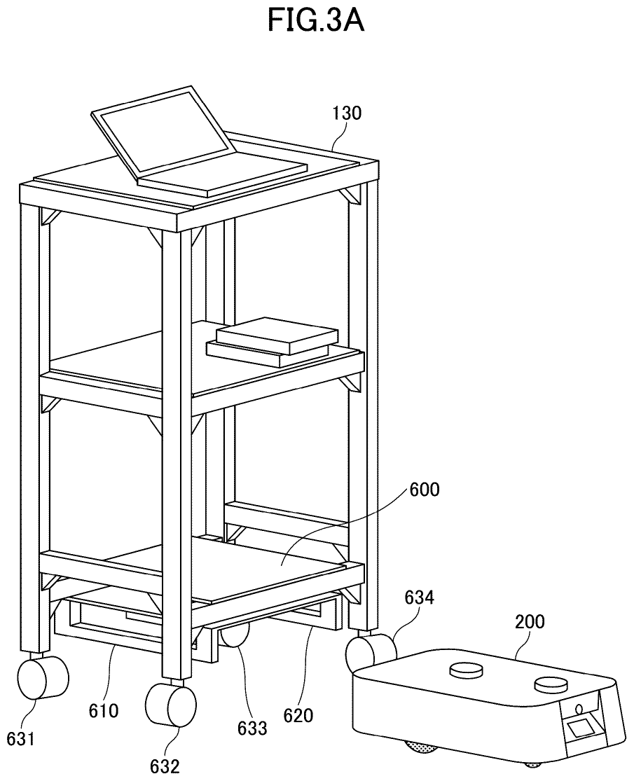

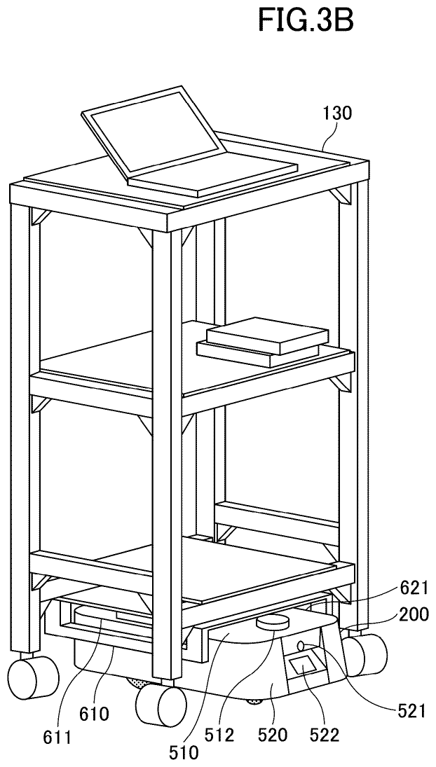

An overview of an operation of the autonomous vehicle 200 docking to the transferred body will be described. FIG. 3A and FIG. 3B are drawings each illustrating a state where the autonomous vehicle docks to a shelf, which is the transferred body. Among these drawings, FIG. 3A illustrates a state immediately before the autonomous vehicle 200 docks to a shelf 130, which is the transferred body, waiting at a position where the shelf 130 is usually located.

As illustrated in FIG. 3A, the shelf 130 has three levels, and frame guides 610 and 620 are attached to a lower side of a lowermost level 600 at an interval corresponding to the width of the autonomous vehicle 200 and substantially in parallel. This defines the entry direction in which the autonomous vehicle 200 enters a space below the lowermost level 600 of the shelf 130, which is the transferred body. Additionally, the frame guides 610 and 620 function as a guide in the width direction and prevent the shelf 130 from being displaced in the width direction with respect to the autonomous vehicle 200 when the autonomous vehicle 200 transfers the shelf 130, which is the transferred body.

The entry direction is an entry direction for the autonomous vehicle 200 to bring the transferred body into a transferable state. Here, the transferable state includes a state in which the autonomous vehicle 200 docks to the transferred body. Additionally, the transferable state includes a state in which the autonomous vehicle 200 can transfer the transferred body by pushing, lifting, gripping, placing, towing the transferred body or the like. Additionally, the transfer includes moving the transferred body to another place by the autonomous vehicle 200. Here, in the present embodiment, the autonomous vehicle 200 enters below the lowermost level 600 to dock to the shelf 130, and thus, the “entry direction” is used to indicate the direction. However, the “traveling direction” may be used in an embodiment in which the transferred body is in a transferable state without the autonomous vehicle 200 entering the transferred body.

Additionally, casters 631 to 634 are rotatably attached to the feet of the shelf 130. This allows the autonomous vehicle 200 to easily transfer the docked shelf 130.

With respect to the above, FIG. 3B illustrates a state after the autonomous vehicle 200 docks to the shelf 130, which is the transferred body. In FIG. 3B, the front surface 520 of the autonomous vehicle 200 protrudes in the forward direction from all levels of the shelf 130 and is not covered by any level of the shelf 130. But depending on the shape or size of the shelf 130, the measurement range of at least one of the front RGB camera 521, the ToF camera 522, or the LiDAR 512 may be blocked by the components (a shelf plate, an upright, a caster, and the like) of the shelf 130. Therefore, in the present embodiment, the shape and dimensions of the shelf 130 may be identified, and the invalid region may be set in the measurement range of at least one of the front RGB camera 521, the ToF camera 522, or the LiDAR 512.

Here, the LiDAR 512 may be blocked by the frame guides 610 and 620 or a component of the shelf 130 with respect to the measurement range in the width direction in a state where the autonomous vehicle 200 docks to the shelf 130. Therefore, the frame guides 610 and 620 of the shelf 130 are provided with openings 611 and 621 in order to reduce the proportion of the blocked measurement range in the width direction of the LiDAR 512.

### <Functional Configuration of Generation Device>

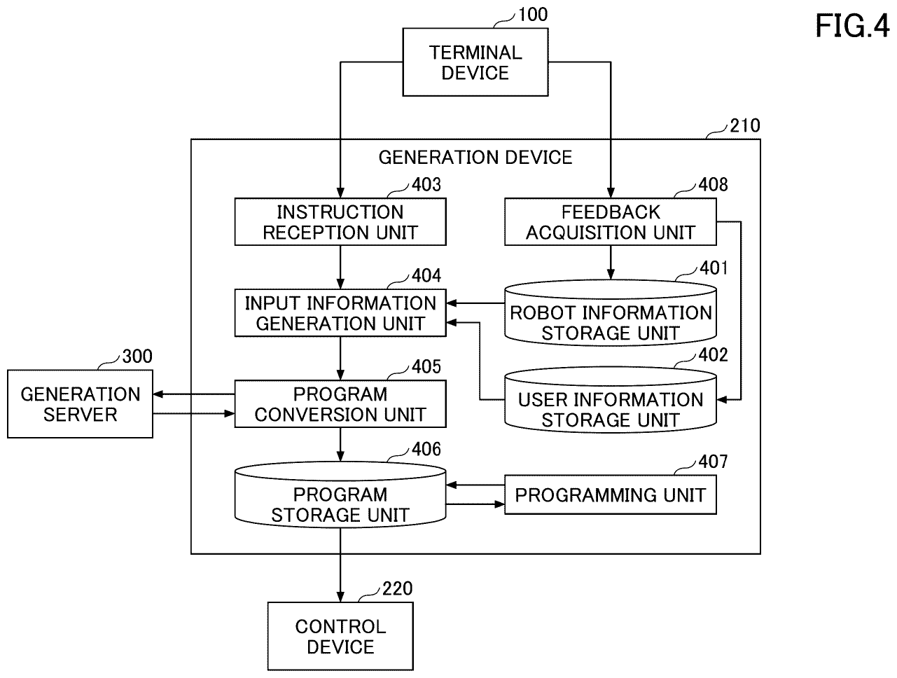

A functional configuration of the generation device according to the present embodiment will be described with reference to FIG. 4. FIG. 4 is a diagram illustrating an example of the functional configuration of the generation device.

As illustrated in FIG. 4, the generation device 210 includes a robot information storage unit 401, a user information storage unit 402, an instruction reception unit 403, an input information generation unit 404, a program conversion unit 405, a program storage unit 406, a programming unit 407, and a feedback acquisition unit 408. A generation program is installed in the generation device 210, and the generation device 210 functions as the instruction reception unit 403, the input information generation unit 404, the program conversion unit 405, the programming unit 407, and the feedback acquisition unit 408 by executing the program.

The robot information storage unit 401 stores information related to the robot 200 (hereinafter, also referred to as “robot information”). The robot information may include information related to self-recognition of the robot 200 (hereinafter, also referred to as “self-recognition information”), information related to a software component used to generate a program (hereinafter, also referred to as “component information”), and information related to an operating environment of the robot 200 (hereinafter, also referred to as “environment information”).

The self-recognition information includes, for example, a hardware configuration, a basic policy, an operation constraint, and the like of the robot 200. The hardware configuration is a specification of hardware that can be used to operate the robot 200. Examples of the hardware configuration include a configuration including two wheels that can move in a plane, one arm that can hold an object, two microphones, one speaker, and one camera. Another example of the hardware configuration may include a configuration including a sensor, such as an inertial sensor, a 3D sensor, a LiDAR, or an ultrasonic sensor, an actuator, such as legs capable of walking on four foot or on two foot and an omnidirectional mechanism, such as mecanum wheels, and an output unit, such as an LED, a display, or a facial expression.

The basic policy is a role, concept, or the like of the robot 200. Examples of the basic policy include supporting the user's life in the home. Other examples of the basic policy may include supporting serving of meals at a restaurant, assisting a person in an office, selecting the shortest route for a given target, avoiding an obstacle if any, and the like.

The operation constraint is a constraint condition or the like to be satisfied for the robot 200 to operate. Examples of the operation constraint include charging with a charger when a task is not executed. Other examples of the operation constraint may include not going to a place having a step, not capturing an image of a place where privacy of a person is concerned, not producing a sound at night, not emitting light at night, not approaching a place having a step, not entering an unenterable area, and not carrying a shelf while carrying another shelf.

The component information includes, for example, information related to an API provided by the robot 200 (hereinafter, also referred to as “API information”), function information indicating a function necessary for generating a program, module information indicating a module necessary for generating a program, and the like.

The API information varies depending on the type of the API. In the execution API, the API information includes, for example, an effect obtained by executing the API, an argument for executing the API, a condition under which the API can be executed, and the like. In the acquisition API, the API information includes, for example, information obtained by executing the API, a condition under which the API can be executed, and the like. In the acquisition API that acquires a barcode for identifying an article of furniture, which is the transferred body, the condition under which the API can be executed may be, for example, that the robot 200 is present in a range of 0.2 m to 1.0 m from the front of the article of furniture.

The API may include, for example, an API of acquiring a map of the environment, recognizing objects captured by the camera and listing them with their locations, moving to a desired location, obtaining a result of voice recognition, listing existing transferred bodies, obtaining a schedule set by the user, causing the robot to speak, and the like.

The environment information includes map information (room layout and the like) indicating a range in which the robot 200 can operate, sensor information measured in the operating environment of the robot 200, and information related to a target object of the operation of the robot 200. The map information includes coordinates of an installation object present in the range in which the robot 200 can operate, and a description (a name, a meaning, or the like) of the coordinates. The sensor information may be sensor data measured by various sensors included in the robot 200 or sensor data measured by various sensors installed in the operating environment of the robot 200. The target object may be, for example, an article of furniture (a shelf with casters or the like), which is an example of the transferred body, and a charger capable of charging the robot 200. The map information may include an area where the robot 200 is permitted to enter, an area where the robot 200 is prohibited from entering, and the like.

The information related to the target object includes coordinates indicating the position of the target object, information related to the name of the target object (a formal name, an abbreviated name, a name used for voice recognition, and the like), a relation between the target object and another target object, and the description of the target object (the size, the place where the target object is usually placed, and the like). The relation between the target object and another target object includes, for example, a pen placed on a bookshelf, a green tea PET bottle placed on a drink shelf, and the like. The description of the target object includes the external dimensions of the target object (such as the size of shape), a handling rule of the target object (such as transferring the target object to a predetermined position on the bookshelf when the bookshelf is not in use), and the like.

The environment information may be information related to the current operating environment or information related to the past operating environment. The information related to the past operating environment may be history information including information related to the operating environment at multiple different points in time.

When the robot 200 is an autonomous vehicle, the robot information may include, for example, a characteristic of the furniture itself, a destination corresponding to the characteristic of the furniture, an operation constraint on a map, a characteristic of the robot itself, and the like.

The characteristic of the furniture itself may include, for example, which items are on which shelves, the size of the interior of the article of furniture (the volume, footprint, or the like), the compatibility of the article of furniture with the destination, the number of items that can be placed in the article of furniture, a combination that is not good for being placed together (food and garbage, apple and vegetable, and the like), the weight of the article of furniture, and the like.

The destination corresponding to the characteristic of the furniture may include, for example, which articles of furniture are highly related (a kitchen shelf and kitchen are highly related, a seasoning shelf and a bedroom are less related, and the like), clearance required for furniture placement (distance to another installation), a reference landmark (a wall, an article of furniture, a home appliance, and the like), spatial extent (the entire room for a bed room, a space beside a desk for the desk, and the like), preferential performance when carrying an article of furniture to the destination (the position accuracy is reduced with emphasis on the speed, the position accuracy is increased with emphasis on the accuracy, or the like), and contents spoken for each destination.

The operation constraint on the map may include, for example, a track through which the autonomous vehicle passes during transferring, a dangerous area (a step or the like), an area through which the autonomous vehicle can actually pass although the area is an area through which the autonomous vehicle cannot pass according to the map information, an area in which a specific sensor is ignored, and the like.

The characteristic of the robot itself may include, for example, the operable time with respect to the remaining charge (for example, because the operable time per remaining charge changes when the battery deteriorates), the average time taken to complete charging, the rate of decrease in the remaining charge, the speed or acceleration at which the robot can travel, the angular speed or angular acceleration at which the robot can turn, the range or distance at which an article of furniture or obstacles can be detected by the sensor, and the like.

The user information storage unit 402 stores information related to the user of the robot 200 (hereinafter, also referred to as “user information”). The user information may include a history of instructions provided by the user, information related to a habit of the user, information related to preferences of the user, a frequency of instructions provided by the user, and the like.

When the robot 200 is the autonomous vehicle described above, the user information may include a tendency of using an article of furniture, a destination according to a habit of the user, a tendency of a position of the user, and the like.

The tendency of using the article of furniture may include, for example, a use frequency of each article of furniture, a use frequency of each user (when multiple users use the same autonomous vehicle), a tendency of items in the article of furniture, a frequency of manual movement of the article of furniture by the user, a possibility of replacement with another article of furniture (when there are multiple article of furniture having the same role), and the like.

The destination according to the habit of the user may include, for example, statistical information about a frequency of use as a transfer destination for each article of furniture and an occupancy rate. The occupancy rate is a probability that another target object, an installation, or the like is present at the destination.

The tendency of the position of the user may include, for example, a flow line of a person living in the room, a staying position of the user at ordinary times, and the like.

The robot information and the user information may be described in a natural language sentence, for example. That is, the robot information may be a natural language sentence describing each information related to the robot 200, and the user information may be a natural language sentence describing each information related to the user. The robot information described in a natural language sentence may be a sentence such as “There are a drink shelf and a cleaning shelf in this house”, for example.

As another example, the robot information and the user information may be stored in a database in which an item and a value are associated with each other. A method of associating the item with the value may include, for example, storing the item and the value as one set, storing information that enables another information to be acquired from one information, or storing one information and identification information of another information as one set.

The instruction reception unit 403 receives an input of the instruction information indicating an instruction to the robot 200 provided by the user. The instruction to the robot 200 may be an instruction to perform a specific operation desired by the user or may be an instruction to declare a condition expected by the user.

The instruction information may be described in a natural language sentence, for example. The natural language sentence indicating the instruction provided by the user may be input as text by the user or may be generated by recognizing a voice uttered by the user, for example. The instruction reception unit 403 may store the received instruction information in the user information storage unit 402 as the user information.

The instruction reception unit 403 may generate a natural language sentence indicating the instruction provided by the user by collecting a voice uttered by the user with a microphone included in the robot 200 and recognizing an audio signal of the voice. The instruction reception unit 403 may receive, from the terminal device 100, a natural language sentence indicating an instruction input by the user to the terminal device 100 as text. The instruction reception unit 403 may receive, from the terminal device 100, a recognition result obtained by the terminal device 100 recognizing the voice uttered by the user.

The instruction information may include audio information or image information. The audio information may include a voice uttered by the user. The image information may include a still image or a moving image obtained by capturing the user. The image information may be, for example, a still image or a moving image obtained by capturing a gesture performed by the user. The instruction information may include a result of recognizing the audio information or the image information. The result of recognizing the image information may include a result of recognizing the captured gesture.

The input information generation unit 404 generates the input information to be input into the generation module 310 to generate a program. The input information generation unit 404 generates the input information based on the instruction information received by the instruction reception unit 403, the robot information read from the robot information storage unit 401, and the user information read from the user information storage unit 402.

The input information may be described in a natural language sentence, for example. The input information may be audio information or image information. The input information may be sensor information. The input information may be any combination of these pieces of information.

When the instruction information, the robot information, and the user information are described in natural language sentences, the input information generation unit 404 can generate a natural language sentence indicating the input information by connecting the natural language sentences, for example. When the robot information and the user information are stored in the database, the input information generation unit 404 can generate a natural language sentence indicating the input information by, for example, connecting a natural language sentence indicating an instruction to a natural language sentence generated by embedding these information in a template. The input information generation unit 404 may generate a natural language sentence indicating the input information based on a trained sentence generation model, for example.

The natural language sentence indicating the input information may be, for example, “Seasoning, kitchen wrap, kitchen paper, a spoon and fork, and chopsticks are placed in the kitchen shelf. The kitchen shelf has a bottom surface of 40 cm×60 cm and a height of about 1.2 m. The kitchen shelf is housed under the desk of A. Basically, the kitchen shelf is placed in a pantry, but when cooking, the kitchen shelf is often placed on the side of an island kitchen. The top level is open and is used to transfer eating utensils to and from a dining table. From a hygienic point of view, it is not preferable to place garbage there. This month, A uses the kitchen shelf from Monday to Friday in the morning and evening, and B uses the kitchen shelf from the evening to night on Saturday. A bag of a supermarket is placed in the pantry, which is the place where the kitchen shelf is placed, and the place is occupied at a frequency of 18%”.

In the above sentence, the portion “Seasoning, kitchen wrap, kitchen paper, a spoon and fork, and chopsticks are placed in the kitchen shelf . . . . From a hygienic point of view, it is not preferable to place garbage there.” is a sentence generated by embedding the robot information in the template. Additionally, in the above sentence, the portion “This month, A uses the kitchen shelf from Monday to Friday in the morning and evening, and B uses the kitchen shelf from the evening to night on Saturday. A bag of a supermarket is placed in the pantry, which is the place where the kitchen shelf is placed, and the place is occupied at a frequency of 18%” is a sentence generated by embedding the user information in the template.

The input information may include, for example, the following robot information.
The camera, the recognition module, and the distance sensor are enabled to recognize a person, and the bounding box output by the person recognition module and the output from the distance sensor are integrated to obtain a recognition result.
A place reachable from the charger is selected as a candidate by using the map information held by the autonomous movement component in order to determine a destination of the robot.
When DetectPerson, which is the API, is activated, the position of a person on the map represented by x and y coordinates can be detected.
The environmental information on the robot
Information related to a software component necessary for acquiring the environment information on the robot

The input information may include, for example, self-recognition information included in the robot information.

The input information may include, for example, a natural language sentence indicating specific instruction information from the user. The input information may include the instruction information itself. The instruction information may be, for example, the following sentence.
Discard the trash.
Bring a spoon.
Take shelf A to the sofa at 7 o'clock every Monday night

The program conversion unit 405 generates a program based on the input information generated by the input information generation unit 404. The program conversion unit 405 transmits a generation request including the input information to the generation server 300. When receiving the program from the generation server 300, the program conversion unit 405 stores the program in the program storage unit 406.

The program storage unit 406 stores the program generated by the program conversion unit 405. The program storage unit 406 may store multiple programs.

The programming unit 407 updates the program stored in the program storage unit 406 in accordance with an edit operation by the user. The programming unit 407 transmits, to the terminal device 100, screen data for displaying a programming screen on which visual programming can be performed. On the programming screen, the contents of the program selected by the user are displayed. The programming unit 407 edits the program in accordance with the user's operation on the programming screen, and updates the program stored in the program storage unit 406 based on the edited program.

Here, the visual programming is a method of creating one program by arranging program components having predetermined functions and connecting the program components. The program components include, for example, a program component having a function of executing an API provided by the robot 200, a program component having a function related to execution control, such as conditional branching or repetition, and a program component having a function of performing an operation on a variable that can be handled in the program.

The feedback acquisition unit 408 updates the robot information or the user information based on feedback information input by the user. The feedback information is a natural language sentence indicating a feedback of the user with respect to a result of the operation performed according to the program by the robot 200. As an example, the feedback acquisition unit 408 may acquire the feedback information input by the user as text or may acquire the feedback information by recognizing a voice uttered by the user, as with the instruction reception unit 403.

The feedback acquisition unit 408 may update the robot information based on the feedback information. The feedback information for updating the robot information may be, for example, “even if a person comes, I do not have to meet the person at night” or the like. When such feedback information is acquired, the feedback acquisition unit 408 is only required to add, to the robot information, an operation constraint indicating that “I do not meet the person at night even if the person comes”. The feedback information for updating the robot information may be “it is not allowed to enter the room”, “move more carefully and slowly”, or the like as another example. When such feedback information is acquired, the feedback acquisition unit 408 may update the maximum speed of the robot, the no-entry area, or the like included in the robot information.

The feedback acquisition unit 408 may update the user information based on the feedback information. The feedback information for updating the user information may be, for example, “the person does not call a shelf for sweets” or the like. When such feedback information is acquired, the feedback acquisition unit 408 may add, to the user information, information indicating the user's preference regarding sweets.

Here, the robot information or the user information updated by the feedback acquisition unit 408 may be used to generate the input information when a program is generated next time or later.

The generated program can combine various APIs provided by the robot 200 to execute not only the task but also the acquisition of the sensor data, the subtask for satisfying the execution condition of the task, and the like. That is, the generated program can accurately execute a complicated logic based on various information.

However, the robot 200 operates in a real space in which the state changes every moment, and thus the generated program is not necessarily perfect, and the robot 200 may fail to operate or perform an inappropriate operation. For example, the operating time may be delayed by performing state acquisition that is essentially unnecessary. Additionally, for example, a condition necessary for acquiring a state is not satisfied, and thus a correct state may not be acquired.

Further, for example, the operation of the robot 200 may end up with a result that does not meet the expectation of the user. Examples of the result that does not meet the user's expectation include a case where the shelf on which the pen is supposed to be placed is transferred in response to the operation instruction “bring pen”, but the pen is actually placed on a different shelf. At this time, by the user providing feedback information, for example, “the pen is placed on the bookshelf”, the information related to the target object of the operation is updated to correct the contents, and the operation following the user's expectation is realized in the subsequent operations.

### <Flow of Generation Processing>

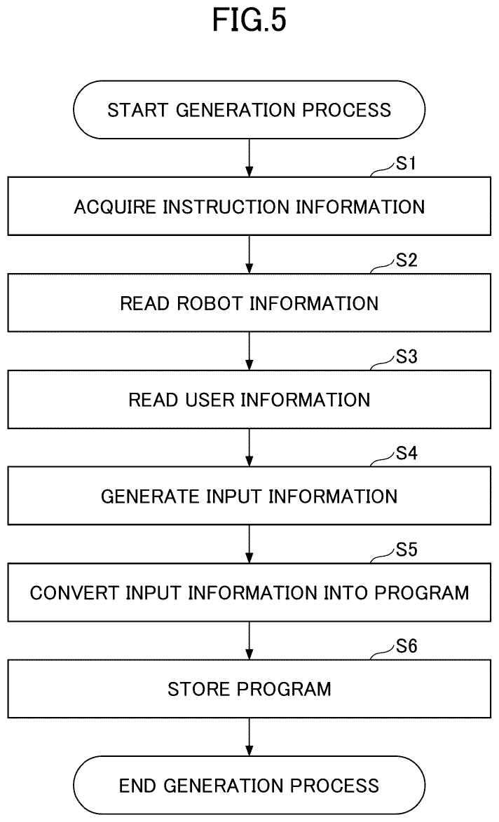

A generation process performed by the generation device 210 according to the present embodiment will be described with reference to FIG. 5. FIG. 5 is a flowchart illustrating an example of the generation process. The generation process is a process of generating the program for controlling the operation of the robot 200.

In step S1, the user of the robot 200 inputs, to the terminal device 100 or the robot 200, the instruction to the robot 200. The user may utter, to the terminal device 100 or the robot 200, the natural language sentence indicating the instruction to the robot 200. In this case, the terminal device 100 or the robot 200 recognizes the voice uttered by the user to generate the instruction information. The user may input the natural language sentence indicating the instruction to the robot 200 as text to the terminal device 100. In this case, the terminal device 100 acquires the instruction information input by the user as text.

In the generation device 210, the instruction reception unit 403 receives an input of the instruction information indicating the instruction from the user. Next, the instruction reception unit 403 transmits the received instruction information to the input information generation unit 404.

In step S2, the input information generation unit 404 of the generation device 210 receives the instruction information from the instruction reception unit 403. Next, the input information generation unit 404 reads the robot information from the robot information storage unit 401. The input information generation unit 404 may read all the robot information stored in the robot information storage unit 401 or may read only a part of the robot information. The robot information read by the input information generation unit 404 may be selected based on the instruction information. The input information generation unit 404 may be configured to set multiple options as the input information based on the robot information and the generation module 310 may be configured to select one of the options.

In step S3, the input information generation unit 404 of the generation device 210 reads the user information from the user information storage unit 402. The input information generation unit 404 may read all the user information stored in the user information storage unit 402 or may read only a part of the user information. The user information read by the input information generation unit 404 may be selected based on the instruction information. For example, the input information generation unit 404 may be configured to set multiple options as the input information based on the user information, and the generation module 310 may be configured to select one of the options.

In step S4, the input information generation unit 404 of the generation device 210 generates the input information based on the instruction information acquired in step S1, the robot information read in step S2, and the user information read in step S3. Next, the input information generation unit 404 transmits the generated input information to the program conversion unit 405.

In step S5, the program conversion unit 405 of the generation device 210 receives the input information from the input information generation unit 404. Next, the program conversion unit 405 generates the generation request for requesting the generation of the program. The generation request includes the input information. Subsequently, the program conversion unit 405 transmits the generation request to the generation server 300.

The generation server 300 receives the generation request from the generation device 210. Next, the generation server 300 extracts the input information from the received generation request. Subsequently, the generation server 300 inputs the input information into the generation module 310. The generation module 310 generates the program based on the input information and outputs the program. The generation server 300 transmits the program output from the generation module 310 to the generation device 210.

In step S6, the program conversion unit 405 of the generation device 210 receives the program from the generation server 300. The program conversion unit 405 stores the received program in the program storage unit 406.

### <Flow of Edit Process>

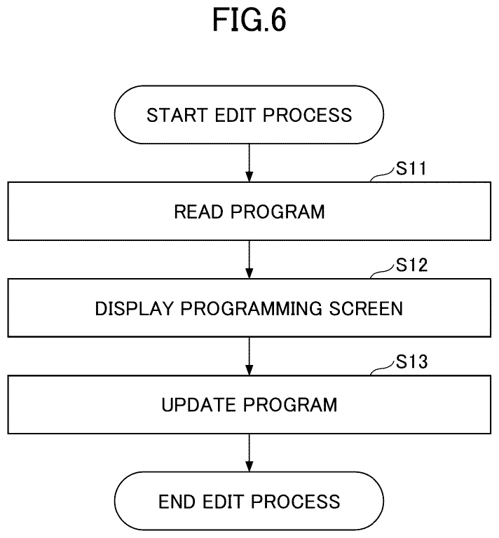

An edit process performed by the generation device 210 according to the present embodiment will be described with reference to FIG. 6. FIG. 6 is a flowchart illustrating an example of the edit process. The edit process is a process of editing the program generated by the generation device 210.

In step S11, the user of the robot 200 performs an operation of displaying the programming screen on the terminal device 100. The operation of displaying the programming screen is performed by selecting the generated program. For example, the terminal device 100 outputs a list of generated programs to the display device, and the user performs an operation of selecting the generated program from the list, so that the operation of displaying the programming screen is performed. The terminal device 100 transmits an edit request for requesting the editing of the program to the generation device 210. The edit request includes information indicating the program selected by the user.

In the generation device 210, the programming unit 407 receives the edit request. Next, the programming unit 407 extracts information indicating the program from the received edit request. Subsequently, the programming unit 407 reads the program selected by the user from the program storage unit 406 based on the information indicating the program.

In step S12, the programming unit 407 generates a screen for displaying the programming screen. The contents of the read program are embedded in the screen data.

Here, the programming screen is a screen on which visual programming can be performed. In the visual programming, by arranging program components having predetermined functions and connecting the program components, one program is created, and therefore, the program displayed on the programming screen is a drawing in which the program components corresponding to the functions are connected according to the order of processing, conditional branching, and the like.

Next, the programming unit 407 transmits the screen data for displaying the programming screen to the terminal device 100. The terminal device 100 receives the screen data from the generation device 210. Then, the terminal device 100 outputs the programming screen on which the contents of the generated program are graphically displayed to the display device based on the received screen data.

In step S13, the user of the robot 200 performs an operation of editing the program on the programming screen output to the display device of the terminal device 100. The operation of editing the program includes, for example, addition or deletion of a program component, a change in connection between program components, a change in a property of a program component, and the like. The terminal device 100 edits the program in accordance with the user's operation on the programming screen. Next, the terminal device 100 transmits the edited program to the generation device 210.

In the generation device 210, the programming unit 407 receives the edited program from the terminal device 100. Next, the programming unit 407 generates a new program based on the edited program. Then, the programming unit 407 stores the generated program in the program storage unit 406. The programming unit 407 may overwrite the existing program with the new program, or may store the new program separately from the existing program.

Here, the edit process need not necessarily be performed. Whether to perform the edit process depends on whether the user wants to edit the generated program by checking the generated program. That is, the edit process is not performed unless the user performs an operation to display the programming screen.

### <Flow of Execution Process>

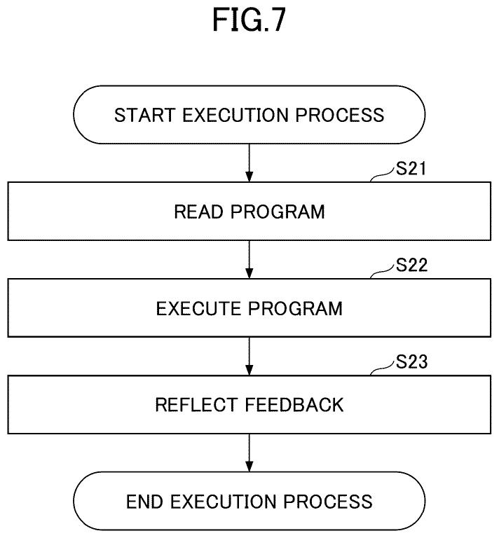

An execution process performed by the control device 220 according to the present embodiment will be described with reference to FIG. 7. FIG. 7 is a flowchart illustrating an example of the execution process. The execution process is a process of controlling the operation of the robot 200 according to the program generated by the generation device 210.

In step S21, the control device 220 reads the program stored in the program storage unit 406 of the generation device 210. The control device 220 may read all the programs stored in the program storage unit 406 or may read a part of the programs in response to a predetermined trigger. The predetermined trigger may include, for example, when a condition for starting the execution of the program is satisfied, or when the program is called from another program.

The condition for starting the execution of the program may be, for example, detection of a person approaching the house by a GPS, input of a specific command by a voice, ringing of a chime at the entrance, recognition of a specific person by an image, or the like.

In step S22, the control device 220 executes the program read in step S21. In other words, the control device 220 controls the operation of the robot 200 according to the read program.

When the control device 220 executes the program online, the control device 220 executes the program acquired from the generation module 310 in the generation process. In this case, the control device 220 is only required to hold the program acquired in step S6 of the generation process in the memory and execute the program.

In step S23, the feedback acquisition unit 408 of the generation device 210 receives an input of the feedback information from the user. Next, the feedback acquisition unit 408 updates the robot information stored in the robot information storage unit 401 or the user information stored in the user information storage unit 402 based on the input feedback information.

### SUMMARY

As is clear from the above description, the generation device 210 according to the embodiment acquires the instruction information for the robot 200 provided by the user, generates the input information for the generation module 310 based on the robot information and the instruction information, and acquires the program for controlling the operation of the robot 200, generated by inputting the input information into the generation module 310. The robot information includes information related to at least one of the operating environment of the robot 200 or a software component for acquiring the information related to the operating environment.

The robot information may include information related to self-recognition of the robot 200.

The information related to the software component may include an execution condition of the software component. The information related to the operating environment may include the map information of the environment in which the robot 200 operates. The information related to the operating environment may include information related to the target object of the operation of the robot 200. The information related to the target object may include at least a position or a name of the target object.

The generation device 210 may generate the input information based on the user information. The user information may include information related to at least one of a history of instructions provided by the user, a habit of the user, or a preference of the user.

The generation device 210 may generate the program by inputting the input information into the generation module 310.

The generation device 210 may acquire the feedback information from the user with respect to a result of the operation of the robot 200 based on the execution of the program and generate second input information for the generation module 310 based on the feedback information.

The program may be generated by one or more information processing devices communicably connected to the generation device 210 via a network.

The generation device 210 may acquire the instruction information by recognizing the voice of the user.

The generation device 210 may output the screen for editing the program to the display device and edit the program based on an instruction from the user. The program is displayed by arranging program components having predetermined functions and connecting the program components in the screen.

The robot 200 may include the generation device 210 and execute the program. The robot 200 may include the sensor and the movement mechanism. The robot 200 may start the execution of the program in response to a predetermined trigger. The robot 200 may include one or more sensors and acquire desired sensor information by executing the program. The robot 200 may be an autonomous vehicle that docks to the transferred body for transferring.

With this, according to the embodiment of the present disclosure, a device that can easily create a program for controlling an operation of a robot can be provided.

### Other Embodiments

A part or all of the generation device 210 in the above-described embodiment may be configured by hardware, or may be configured by information processing of software (a program) executed by a central processing unit (CPU), a graphics processing unit (GPU), or the like. In the case where the embodiment is configured by the information processing of software, software for realizing at least a part of the functions of the generation device 210 in the above-described embodiment may be stored in a non-transitory storage medium, such as a compact disc-read only memory (CD-ROM) or a universal serial bus (USB) memory, and at least one processor may read the software to execute the information processing of the software. Additionally, the software may be downloaded via a communication network. Furthermore, all or a part of the processing of software may be implemented in a circuit, such as an application specific integrated circuit (ASIC) or a field programmable gate array (FPGA), and the information processing by the software may be executed by hardware.

The storage medium storing the software may be a removable medium, such as an optical disk, or a fixed storage medium, such as a hard disk or a memory. Additionally, the storage medium may be provided inside the generation device 210 (a main storage device, an auxiliary storage device, or the like), or may be provided outside the generation device 210.

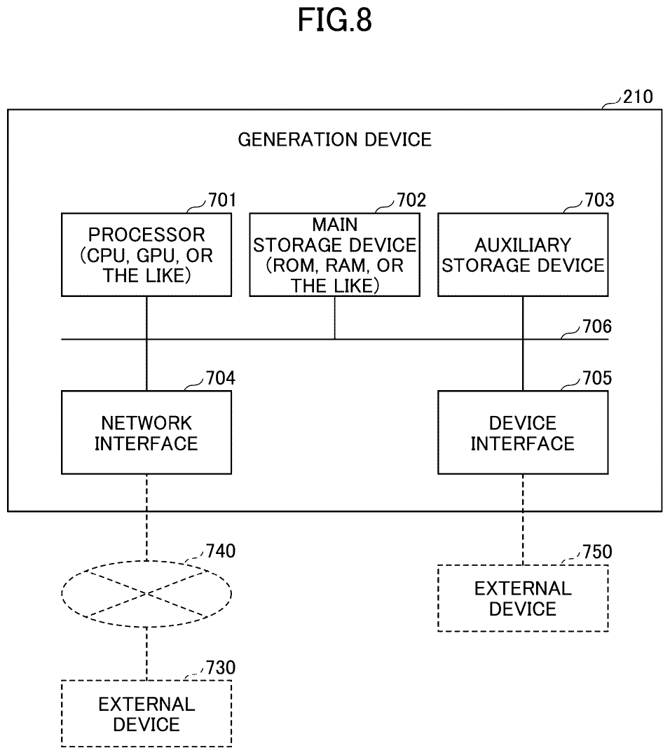

FIG. 8 is a block diagram illustrating an example of a hardware configuration of the generation device 210. The generation device 210 may be implemented as a computer that includes a processor 701, a main storage device 702 (memory), an auxiliary storage device 703 (memory), a network interface 704, and a device interface 705, which are connected to each other via a bus 706, for example.

The generation device 210 of FIG. 8 includes one of each component, but may include multiple units of the same components.

Various operations of the generation device 210 may be executed by parallel processing using one or multiple processors or using multiple computers connected via a network. Additionally, various operations may be distributed to multiple arithmetic cores in the processor 701 and executed by parallel processing. Additionally, a part or all of the processes, means, and the like of the present disclosure may be realized by at least one of a processor or a storage device provided on a cloud communicably connected to the generation device 210 via the network interface 704.

The processor 701 may be an electronic circuit (a processing circuit, processing circuitry, a CPU, a GPU, an FPGA, an ASIC, or the like) that performs at least one of control or operations of the generation device 210. Additionally, the processor 701 may be any of a general-purpose processor, a dedicated processing circuit designed to execute a specific operation, and a semiconductor device including both the general-purpose processor and the dedicated processing circuit. Additionally, the processor 701 may include an optical circuit or may include an arithmetic function based on quantum computing.

The processor 701 may perform arithmetic processing based on data or software input from each device or the like of the internal configuration of the generation device 210, and may output an arithmetic result or a control signal to each device or the like. The processor 701 may control each component constituting the generation device 210 by executing an operating system (OS), an application, or the like of the generation device 210.

The generation device 210 may be implemented by one or more processors 701. Here, the processor 701 may refer to one or more electronic circuits disposed on one chip, or may refer to one or more electronic circuits disposed on two or more chips or two or more devices. When multiple electronic circuits are used, the electronic circuits may communicate with each other through a wired connection or wirelessly.

The main storage device 702 may store instructions executed by the processor 701, various data, and the like, and information stored in the main storage device 702 may be read by the processor 701. The auxiliary storage device 703 is a storage device other than the main storage device 702. Here, these storage devices indicate any electronic components capable of storing electronic information, and may be semiconductor memories. The semiconductor memory may be either a volatile memory or a nonvolatile memory. The storage device for storing various data and the like in the generation device 210 in the above-described embodiment may be realized by the main storage device 702 or the auxiliary storage device 703, or may be realized by an internal memory built in the processor 701. For example, the robot information storage unit 401, the user information storage unit 402, or the program storage unit 406 in the above-described embodiment may be realized by the main storage device 702 or the auxiliary storage device 703.

When the generation device 210 includes at least one storage device (memory) and at least one processor connected (coupled) to the at least one storage device, at least one processor may be connected to one storage device. Additionally, at least one storage device may be connected to one processor. Additionally, a configuration in which at least one processor among the multiple processors is connected to at least one storage device among the multiple storage devices may be included. Additionally, a configuration in which the storage device is integrated with the processor (for example, a cache memory including an L1 cache and an L2 cache) may be included.

The network interface 704 is an interface for connecting to a communication network 740 wirelessly or through a wired connection. As the network interface 704, be an appropriate interface, such as an interface conforming to an existing communication standard, may be used. The network interface 704 may exchange information with an external device 730 connected via the communication network 740. Here, the communication network 740 may be any one of a wide area network (WAN), a local area network (LAN), a personal area network (PAN), and the like, or a combination thereof, and as long as information is exchanged between the generation device 210 and the external device 730. Examples of the WAN include the Internet, examples of the LAN include IEEE802.11 and Ethernet (registered trademark), and examples of the PAN include Bluetooth (registered trademark) and near field communication (NFC).

The device interface 705 is an interface such as a USB that is directly connected to an external device 750.

The external device 730 is a device connected to the terminal device 100 and the generation device 210 via a network. The external device 730 may be, for example, an external server that stores various information used by the terminal device 100, the generation device 210, or the control device 220. The external device 750 is a device directly connected to the generation device 210.

The external device 730 or the external device 750 may be, for example, an input device. The input device is, for example, a device such as a camera, a microphone, a motion capture, various sensors, a keyboard, a mouse, a touch panel, or the like, and provides acquired information to the generation device 210. Alternatively, the device may be a device including an input unit, a memory, and a processor, such as a personal computer, a tablet terminal, or a smartphone.

In the present embodiment, the input device is, for example, an electronic device, such as a camera, a microphone, or various sensors, and provides acquired information to the generation device 210.

Additionally, the external device 730 or the external device 750 may be a storage device (memory). For example, the external device 730 may be a network storage or the like, and the external device 750 may be a storage such as an HDD.

Additionally, the external device 730 or the external device 750 may be a device having a function of a part of the components of the generation device 210. That is, the generation device 210 may transmit a part or all of the processing result to the external device 730 or the external device 750, or may receive a part or all of the processing result from the external device 730 or the external device 750.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

What is claimed is:

1. A generation device comprising:
at least one memory; and
at least one processor,
wherein the at least one processor is configured to:
acquire information from a user;
generate input information for a generation module based on robot information related to a robot and the acquired information; and
acquire a program for controlling an operation of the robot, the program being generated by inputting the input information into the generation module, and
wherein the robot information includes information related to at least one of an operating environment of the robot or a software component for acquiring information related to the operating environment.

2. The generation device as claimed in claim 1, wherein the robot information includes information related to self-recognition of the robot.

3. The generation device as claimed in claim 1, wherein the information related to the software component includes an execution condition of the software component.

4. The generation device as claimed in claim 1, wherein the information related to the operating environment includes at least one of map information of the operating environment, sensor information measured in the operating environment, or information related to a target object of the operation of the robot.

5. The generation device as claimed in claim 4, wherein the information related to the target object includes information related to at least one of a position of the target object, a name of the target object, a relation between the target object and another target object, a size of the target object, a place where the target object is usually placed, or a handling rule of the target object.

6. The generation device as claimed in claim 1, wherein the at least one processor is configured to generate the input information based on information related to the user.

7. The generation device as claimed in claim 6, wherein the information related to the user includes information related to at least one of a history of the acquired information, a habit of the user, or a preference of the user.

8. The generation device as claimed in claim 1, further comprising the generation module, wherein the at least one processor is configured to generate the program by inputting the input information into the generation module.

9. The generation device as claimed in claim 1, wherein the at least one processor is configured to:
acquire feedback information from the user with respect to a result of the operation of the robot, the operation of the robot being based on execution of the program; and
generate second input information for the generation module, based on the feedback information.

10. The generation device as claimed in claim 1, wherein the generation of the program is executed by one or more information processing devices communicably connected to the generation device via a network.

11. The generation device as claimed in claim 1, wherein the at least one processor is configured to acquire the information by recognizing a voice of the user.

12. The generation device as claimed in claim 1, wherein the acquired information includes instruction information for the robot provided by the user.

13. The generation device as claimed in claim 12, wherein the instruction information includes information related to a condition expected by the user.

14. The generation device as claimed in claim 1, wherein the at least one processor is configured to:
display a screen for editing the program on a display device; and
edit the program based on an instruction from the user.

15. The generation device as claimed in claim 14, wherein program components having predetermined functions are arranged and the program components are connected in the screen.

16. A robot comprising the generation device as claimed in claim 1 and configured to execute the program.

17. The robot as claimed in claim 16, wherein the robot starts execution of the program in response to a predetermined trigger.

18. The robot as claimed in claim 16, further comprising one or more sensors, wherein the robot is configured to acquire desired sensor information by executing the program.

19. The robot as claimed in claim 16, wherein the robot is an autonomous vehicle configured to dock to a transferred body for transferring.

20. A generation method comprising:
acquiring, by at least one processor, information from a user;
generating, by the at least one processor, input information for a generation module based on robot information related to a robot and the acquired information; and
acquiring, by the at least one processor, a program for controlling an operation of the robot, the program being generated by inputting the input information into the generation module,
wherein the robot information includes information related to at least one of an operating environment of the robot or a software component for acquiring information related to the operating environment.

21. A non-transitory computer-readable recording medium having stored therein a computer program for causing one or more processors to perform a process comprising:
acquiring information from a user;
generating input information for a generation module based on robot information related to a robot and the acquired information; and
acquiring a program for controlling an operation of the robot, the program being generated by inputting the input information into the generation module,
wherein the robot information includes information related to at least one of an operating environment of the robot or a software component for acquiring information related to the operating environment.
